(19) United States
(12) Patent Application Publication
(10) Pub. No.: US 2010/0227103 A1
(43) Pub. Date: Sep. 9, 2010

(54) ROOFING UNDERLAYMENT

(75) Inventor: Ronald P. Hohmann, JR., Hauppauge, NY (US)

Correspondence Address: SENNIGER POWERS LLP, 100 NORTH BROADWAY, 17TH FLOOR, ST LOUIS, MO, 63102, US

(73) Assignee: MITEK HOLDINGS, INC., Wilmington, DE (US)

(21) Appl. No.: 12/397,898

(22) Filed: Mar. 4, 2009

(51) Int. Cl. D06N 7/04; B32B 33/00

(52) U.S. Cl. 428/41.8; 428/141

(57) ABSTRACT

A roofing underlayment for use in a structure containing a roof having a substrate and a roof fastened with attaching hardware. The roofing underlayment is installed under the roofing material, providing protection against rain, wind, ice and snow. The roofing underlayment has a patterned non-skid surface with a high coefficient of friction. The roofing underlayment contains a durable peel-and-stick pressure-activated adhesive having sufficient tack to durably adhere to the rough and porous substrate and seal around attaching hardware. The roofing underlayment is UV resistant and environmentally-friendly, utilizing recycled and recyclable materials as well as cool roof materials. A second embodiment provides for a subroof panel containing a premounted roofing underlayment on the substrate. The subroof panel is installed directly on the roof frame and contains extensions to adhere to and seal between adjacent subroof panels.

### TECHNICAL FIELD OF THE INVENTION

This invention relates to roofing underlayment. In particular, the invention relates to sheets or webs of material providing a non-skid, reflective secondary covering for a roof. For application efficiency, the roofing underlayment hereof is a peel-and-stick structure. The underlayment is provided in a web form for site installation to an existing substrate or in a subroof panel form with pre-assembled underlayment thereof having peel-and-stick underlayment extensions that adhere to adjacent panels.

### BACKGROUND OF THE INVENTION

Underlayments, being in a secondary role to roof coverings such as shingles, tiles, slate, metal panels, and wood shakes, need to function cooperatively therewith and to fulfill unique requirements independently thereof. Among the independent characteristics required are backup integrity, ease of installation, durability/longevity, environmental friendliness, and compliance with safety and other standards of the building codes.

Backup integrity ensures that, even under severe climatic conditions, the underlayment provides a redundancy in building systems, specifically the roofing system, and does not permit penetration by rain, ice, snow and wind. Underlayments therefore require physical characteristics that complement the primary roofing system. Thus, where shingles weather, underlayment must not; where tiles and slate are fragile, underlayment remains intact; and where wood shakes leak, underlayment is impenetrable. A further redundancy is created through the use of a durable adhesive. When the attaching hardware is driven through the roof, holes and tears are created. The adhesive disclosed in this invention provides a seal around the attaching hardware preventing rain, ice, snow and wind penetration.

The installation described herein employs peel-and-stick techniques which, in turn, relies heavily on adhesives technology for ease of use and labor-saving qualities. More and more underlayment and flashing installations have turned to such procedures. Peel-and-stick underlayments are, for example, described in the Zanchetta et al. patents, U.S. Pat. Nos. 7,132,143; 7,115,313; and, 6,696,125 assigned to Polyglass USA, Inc., Fernley, Nev. 89408, which patents all described modified bitumen underlayments. Peel-and-stick techniques are also present in the masonry flashing patents to Hohmann et al., namely, U.S. Pat. Nos. 6,945,000; 6,928,780; and, 6,584,746, which patents are assigned to the assignee hereof.

The installation aspect also extends to facilitating the installation of the primary roofing material. The underlayment needs a sufficient coefficient of friction to be safe for a roofer walking thereon. The coefficient of friction of sheet materials is taught in Di Pede, U.S. Pat. No. 6,925,766 entitled Multilayer Slip-Resistant Sheet Materials and in Wiercinski et al., U.S. Pat. No. 5,687,517 entitled Skid Resistant Roofing Underlayment. The latter patent is assigned to W.R. Grace & Co.—Conn., New York, N.Y., the manufacturers of Grace Ice & Water Shield® products.

Climatic conditions greatly affect the durability/longevity of roofing underlayments. Extreme heat of the sunbelt has led to more and more rejection of bitumen-based products and the extreme cold of the snowbelt with ice dam formations has led to rejection of low-tensile-strength roofing felts. In response, ice shield products have proliferated as shown in the patent review, infra.

Environmental concerns are addressed herein by the use of recycled materials in constructing the underlayment, and by meeting recycling criteria for waste and used underlayment. Further, the textured non-skid coating utilizes cool roof technology. The non-skid coating is manufactured with highly reflective, highly emissive materials that stay 50 to 60 degrees F. cooler than a normal tile roof under a hot summer sun. The use of such materials in a roofing system that has a pocket of air between the roofing underlayment and the roofing materials cuts building owners' energy costs because cool roofs gain less heat than normal roofs, reducing the air conditioning load.

The inventors' patents and their assignee's product line are related to building structures and include insulation, anchoring and seismic devices, and flashing and are sold under the trademarks of Seismiclip®, Byna-Tie®, DW-10-X®, and FLEX-FLASH™. These products, which are manufactured by Hohmann & Barnard, Inc., Hauppauge, N.Y. 11788, now part of Mitek, a subsidiary of Warren Buffet's Berkshire Hathaway, Inc. have become widely accepted in the industry and have provided the inventors with particular insight into the technological needs of this marketplace.

In preparing for this application the following patents and published patent applications came to the attention of the inventors and are believed to be relevant in this discussion of the prior art:

ISSUED PATENTS

| Item | Pat. No. | Inventor | Issue Date |
|---|---|---|---|
| 1. | 7,132,143 | Zanchetta et al. | Nov. 07, 2006 |
| 2. | 7,115,313 | Zanchetta et al. | Oct. 03, 2006 |
| 3. | 6,936,329 | Kiik et al. | Aug. 30, 2005 |
| 4. | 6,925,766 | Di Pede | Aug. 09, 2005 |
| 5. | 6,864,194 | Hindi et al. | Mar. 08, 2005 |
| 6. | 6,794,449 | Fisher | Sep. 21, 2004 |
| 7. | 6,764,968 | Hindi et al. | Jul. 20, 2004 |
| 8. | 6,696,125 | Zanchetta et al. | Feb. 24, 2004 |
| 9. | 6,586,353 | Kiik et al. | Jul. 01, 2003 |
| 10. | 6,308,482 | Strait | Oct. 30, 2001 |
| 11. | 6,296,912 | Zickell et al. | Oct. 02, 2001 |
| 12. | 5,687,517 | Wiercinski et al. | Nov. 18, 1997 |
| 13. | 4,992,315 | Zickell | Feb. 12, 1991 |
| 14. | 4,543,158 | Bondoc et al. | Sep. 24, 1985 |

PUBLISHED PATENT APPLICATIONS

| Item | Publication No. | Inventor | Pub. Date |
|---|---|---|---|
| 15. | 2008/0047212 | Scoville et al. | Feb. 28, 2008 |
| 16. | 2007/0261340 | Cecilio et al. | Nov. 15, 2007 |
| 17. | 2006/0286347 | Mehta et al. | Dec. 21, 2006 |
| 18. | 2006/0263596 | Bamborough et al. | Nov. 23, 2006 |
| 19. | 2006/0251890 | Lane et al. | Nov. 09, 2006 |

U.S. Pat. No. 4,543,158, Bondoc et al. Sep. 24, 1985 This patent pertains to a sheet-type felt that can be used as underlayment for siding or roofing. The felt is comprised of glass fibers, cellulose fibers, binder and asphalt.

U.S. Pat. No. 4,992,315, Zickell et al. Feb. 12, 1991 This patent pertains to a bituminous roofing membrane and method of manufacture. It has a reinforcing mat sandwiched between top and bottom layers of a tacky polymer modified bitumen. The top layer has a nonslip film. A release sheet is provided on the bottom layer to prevent the top and bottom layers from adhering to each other during storage/shipping, when the membrane is rolled up.

U.S. Pat. No. 6,296,912, Zickell Oct. 2, 2001 The roofing membrane of this patent is composed of a woven or nonwoven fibrous mat having an adhesive asphalt coating.

U.S. Pat. No. 6,308,482, Strait Oct. 30, 2001 This patent discloses a reinforced roofing underlayment that provides a waterproof barrier for the roof structure. The underlayment includes a mesh of interwoven thermoplastic strands, with waterproofing material affixed to at least one side. Preferable, the waterproofing material is a layer of thermoplastic film extruded over both sides. The confirmation of Strait '482 provides a reinforced roofing underlayment having an increased tensile strength to resist tearing as well as an increased resistance to deterioration from exposure to external elements.

U.S. Pat. No. 6,586,353, Kiik et al. Jul. 1, 2003 This patent relates to a roofing underlayment system with two layers—a coated substrate having an ionic charge and a layer of felt material. The felt material may be saturated with asphalt.

U.S. Pat. Nos. 6,764,968 and 6,864,194, Hindi et al. Jul. 20, 2004 and Mar. 8, 2005, respectively These patents disclose a reinforced membrane, well suited for use in a single ply roofing system. The membrane is composed of two sheets of thermoplastic olefin (TPO) with a polypropylene reinforcing mesh between them, bonded to both sheets of TPO. The membrane is recyclable.

U.S. Pat. No. 6,794,449, Fisher Sep. 21, 2004 This patent pertains to an adhesive for adhering roofing materials and to roofing articles incorporating the adhesive composition. The adhesive is hot melt pressure-activated peel-and-stick.

U.S. Pat. No. 6,936,329, Kiik et al. Aug. 30, 2005 This patent discloses a fastener-free roofing product comprising a roofing material and an interply material pre-attached to the roofing material. The interply material is water-resistant and includes an adhesive coating on one side. The adhesive used is SBS modified asphalt.

U.S. Patent Applications 2006/0251890 and 2006/0263596, Lane et al. Nov. 9, 2006 and Bamborough et al. Nov. 23, 2006, respectively These applications pertain to a pressure sensitive adhesive (PSA) laminate comprising at least one outer filmic layer of a filmic polymer, at least one adhesive base layer of adhesive base polymer, and at least one tackifier layer comprising at least one polymer.

U.S. Patent Application 2006/0286347, Mehta et al. Dec. 21, 2006 This application discloses a breathable, non-asphaltic roofing underlayment composed of two perforated coated scrims with a breathable thermoplastic film bonded to and sandwiched between them.

U.S. Pat. Nos. 6,696,125, 7,115,313 and 7,132,143, Zanchetta et al. Feb. 24, 2004, Oct. 3, 2006 and Nov. 7, 2006, respectively These patents disclose self-adhering modified bituminous roof underlayments and roof covering composites. The roofing membranes and shingles have a factory-applied self-adhesive layer on the bottom surface and a thermoplastic modifier such as atactic polypropylene (APP) modified bituminous compound on the top surface.

U.S. Patent Application 2007/0261340, Cecilio et al Nov. 15, 2007 This application discloses a method and system of installing sheathing components to a building. The method and system includes color coded roofing panels having a water-resistant major surface. Seaming tape is applied to seams located between adjacent assembled roofing panels.

U.S. Patent Application 2008/0047212, Scoville et al. Feb. 28, 2008 This application discloses self-spacing wood composite panels that address dimensional changes that occur when exposed to elevated moisture conditions. One form of spacer disclosed in the application is a self-spacing adhesive that is applied on the edges of a roof panel.

U.S. Pat. No. 5,687,517, Wiercinski et al. Nov. 18, 1997 Wiercinski '517 discloses a skid-resistant roofing underlayment. The roofing underlayment comprises a waterproofing membrane attached to a carrier sheet that is corrugated to provide skid resistance when installed on a sloped roof.

U.S. Pat. No. 6,925,766, Di Pede Aug. 9, 2005 This patent discloses a polymeric multi-layer sheet material for use as a roofing underlayment that contains noded mesh material laminated to a structural layer. The noded mesh material provides a slip resistant walking surface during installation in dry, wet or dusty conditions.

The present invention provides an advancement in roof underlayment products. The adhesive-backed underlayment provides dual-layered waterproofing protection and resists tearing and slicing. The top layer is specially treated to provide non-slip patterned surface for worker safety and is easy to install, lapping easily by pressing at the overlap.

The adhesive contains up to 50% recycled content and can be installed under metal roofing in temperatures as low as 25 degrees F. The underlayment is self-sealing around fasteners and will not rot, crack or drool like typical rubberized-asphalt adhesives.

The roofing underlayment of this invention provides a combination of a polymeric laminate with a pressure activated hot melt adhesive and release paper thereon. It has departed from the felt paper and bitumen teachings of the past and proceeded toward a new combination that advances the state-of-the-art while taking advantage of labor-saving, peel-and-stick installation techniques.

### SUMMARY

In general terms, the roofing underlayment disclosed hereby is an integral part the roofing system for a building. The roofing underlayment is disposed between the substrate and roofing materials protecting against rain, wind, snow and ice. The roofing underlayment is composed of cool roof materials and manufactured with recycled material.

A first embodiment of the roofing underlayment includes a membranous backing layer, textured coating and a pressure activated hot melt adhesive layer. The adhesive is selected for compatibility with a peel-and-stick installation, thus, upon pressure activation, when, for instance, the roofing underlayment with the hot melt adhesive thereon is pressed against the rough surface of the substrate, a durable bond is created. The adhesive has sufficient tack to seal any fastener holes created by the installation of the roofing materials. The textured coating has a patterned surface with a high coefficient of friction that provides a non-skid surface.

A second embodiment of this invention is a subroofing panel which includes a substrate and a roofing underlayment adhered to the substrate. The roofing underlayment is adhered to the substrate at the factory with an adhesive and a durable bond is created. The roofing underlayment, which is comprised of a membranous backing layer, textured coating and an adhesive, extends beyond the sides and lower portion of the substrate by approximately three inches in each direction. The roofing underlayment extensions utilize a pressure activated adhesive with a release sheet and are adhered to adjacent subroofing panels. The roofing underlayment extensions provide a watertight seal between the subroofing panels. Any unused roofing underlayment extensions are easily removed with a blade onsite.

The adhesive has sufficient tack to seal around the attaching hardware. The textured coating has a patterned surface with a high coefficient of friction that provides a non-skid surface. The subroofing panel of this embodiment is fastened directly to the roof frame.

### OBJECTS AND FEATURES OF THE INVENTION

It is an object of the present invention to provide in a roofing underlayment for residential and commercial construction, a laminated polymeric membrane with hot melt adhesive thereon which upon pressure activation strongly adheres to the rough and porous surfaces of the substrate.

It is another object of the present invention to provide in a roofing underlayment for residential and commercial construction, a polymeric membrane free of bituminous or asphaltic coatings, which membrane is impervious to rain, ice, snow and wind.

It is yet another object of the present invention to provide a labor-saving roofing underlayment utilizing peel-and-stick components that are easy and economical to apply.

It is still yet another object of the present invention to provide a roofing underlayment which operates cooperatively with present roofing media such as shingles, tiles, slate, metal panels and wood shakes.

It is a feature of the present invention that, upon installation, the exposed surface of the roofing underlayment by virtue of its high coefficient of friction is slip resistant and provides a safe surface for the roofer.

It is another feature of the present invention that the polymeric membrane hereof is ultra-violet resistant and the adhesive layer includes an embedded recycled material—both inorganic (glass, fly ash, etc.) and organic (polymeric fibrous fragments, etc.)—to enhance tear and puncture resistance.

It is yet another feature of the present invention that the hot melt adhesive portion thereof has sufficient tack to completely seal against roofing nails attaching the primary roofing to the substrate.

Other objects and features of the present invention will become apparent upon reviewing the drawing and reading the detailed description which follows.

### BRIEF DESCRIPTION OF THE DRAWINGS

In the following drawings, the same parts in the various views are afforded the same reference designators.

FIG. 1 is a perspective view of a roofing underlayment of this invention and shows a substrate onto which the roofing underlayment is applied;

FIG. 2 is a perspective view of a roofing underlayment of this invention and shows a shingle roofing applied thereover;

FIG. 3 is a perspective view of the uninstalled peel-and-stick roofing underlayment of FIG. 1 with successive laminae partially broken away to show details of the structure thereof;

FIG. 4 is a cross-sectional view of the uninstalled peel-and-stick roofing underlayment of FIG. 3.

FIG. 5 is a perspective view of a second embodiment of the uninstalled peel-and-stick roofing underlayment of this invention with successive laminae and substrate partially broken away to show details of the structure thereof;

FIG. 6 is cross-sectional view of the uninstalled roofing underlayment of FIG. 5.

FIG. 7 is a perspective view of a roofing underlayment of FIG. 5 and shows a roof frame onto which the roofing underlayment is applied.

### DESCRIPTION OF THE PREFERRED EMBODIMENTS

In the embodiments described hereinbelow, the roofing underlayment of this invention employs an innovative design with novel material that works in conjunction with the substrate and roofing materials to form a roof system that withstands adverse weather conditions. The novel roofing underlayment is a peel-and-stick laminae sheet that is disposed on the substrate and under the roofing materials.

As used herein, “wood composite” is defined as a composite material that comprises wood and one or more other additives, such as adhesives or waxes. Examples of wood composite materials include oriented strand board (“OSB”), waferboard, particle board, chipboard, medium-density fiberboard, plywood, and boards that are a composite of strands and ply veneers. As used herein, “flakes,” “strands,” and “wafers” are considered equivalent to one another and are used interchangeably. As used herein “emissive” is defined as a measurement of wavelength range in microns following the method set forth in ASTM E408. Within this definition, the level of emittance experienced is greater than 0.75. As used herein, “reflective” is defined as a measurement of Diffuse Luminous Reflectance in accordance with ASTM E903 as measured in nanometers (nm). Within this definition, the level of initial reflectance experienced is greater than or equal to 0.65 for low-slope roofs. After three years, an acceptable level of reflectance is greater than or equal to 0.50. The levels of emittance and reflectance are determined by Energy Star and the Cool Roof Rating Council.

Proper design and construction of roofs are necessary to prevent water penetration. The roof is designed to protect against adverse weather condition which would otherwise seep into the building structure causing damage to the structure. Construction of roof systems are designed to combat water penetration.

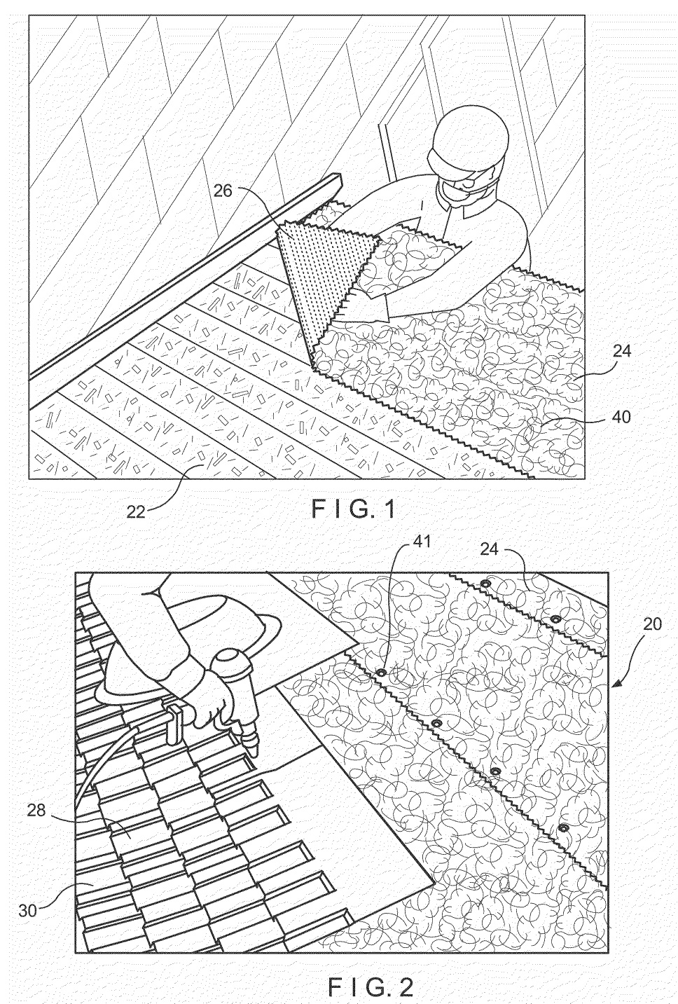

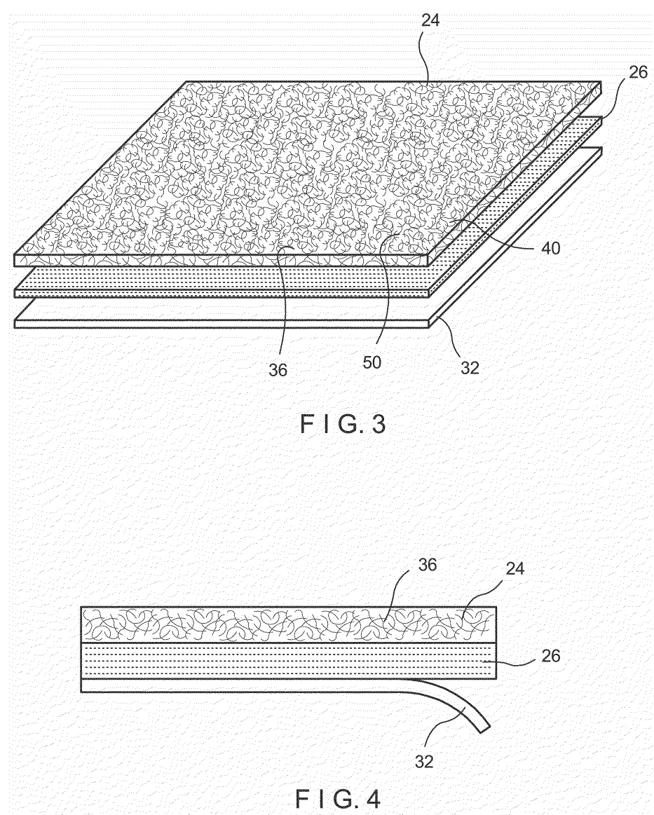

Referring now to FIGS. 1 through 4, views of the first embodiment of this invention in which a roof system, referred to generally by the reference designator 20, is shown. In this embodiment a roof system 20 is shown having a rough and porous substrate 22 made of a wood composite material. The roofing underlayment 24 is adhered to the installed substrate 22 with the pressure-activated hot melt adhesives 26. Primary roof covering or shingles 28 are installed over the roofing underlayment 24 using attaching hardware 41.

The roofing underlayment 24 is generally manufactured in rolls. On site, the roofing underlayment 24 is unrolled and installed starting from the lowest part of the roof 30 and working across and upward. To install the roofing underlayment 24, the craftsman peels the release sheet 32 on the bottom of the pressure-activated adhesive layer 26 and adheres the roofing underlayment to the substrate 22, creating a durable bond. The peel-and-stick adhesive layer 26 allows for easy installation, saving both labor hours and costs.

Once the initial section of the roofing underlayment 24 is adhered to the substrate 22, the craftsman is able to walk on the roofing underlayment 24 and continue installing the roofing underlayment 24 to the substrate 22 until the substrate 22 is completely covered. The patterned surface of the textured coating 36 of the roofing underlayment 24 assists the craftsman in safely installing the roofing underlayment 24 and the roof covering 28. The textured coating 36 contains a patterned surface 50 that provides a high coefficient of friction, non-skid surface 40, allowing the craftsman to install the roofing underlayment 24 and roof covering 28 in a safe manner. The roofing underlayment 24 is ultra-violet resistant, and resists deterioration from exposure to the sun.

The roofing underlayment 24 is composed of a textured coating 36 that is formed from cool roof materials such as Elvaloy® KEE (a DuPont registered trademark for ketone ethylene ester) or equivalent. Cool roof materials are highly reflective, highly emissive roofing materials that stay 50 to 60 degrees F. cooler than a normal tile roof under a hot summer sun. Such materials obtain up to a 0.919 level of emittance and up to a 0.87 level of initial reflectance. The level of reflectance after three years is up to 0.76. Cool roofs cut energy costs in a roofing system that has air space between the roofing underlayment 24 and the roof covering 28 by reducing the air conditioning load. The use of cool roof materials cuts maintenance costs and increases the life expectancy of the roof. Because cool roofs save money and energy, in October 2005, cool roofs became part of California's energy code, the Title 24 Building Energy Efficiency Standards. Further environmental benefits are provided by the pressure-activated adhesive layer 26 which is manufactured using environmentally friendly components. The adhesive layer 26 includes embedded recycled material—both inorganic (glass, fly ash, etc.) and organic (polymeric fibrous fragments, etc.)—to enhance tear and puncture resistance.

Once the roofing underlayment 24 is installed on the substrate 22, the roof covering 28 is installed starting from the bottom of the roof 20 and moving upward. The textured coating 36 provides a high coefficient of friction to create a non-skid surface to assist the laborer in safely installing the roof covering 28. The roof covering 28 is installed using attaching hardware such as nails 41. The adhesive layer 26 has sufficient tack to provide a seal around the nails 41 and any holes or tears created during installation of the roof covering 28.

The adhesives described herein are particularly useful for peel-and-stick applications in the building construction industry as such adhesives are readily pressure activated after the release paper is removed. The adhesive is formulated so that, in case of fire, the coatings thereof will not contribute to smoke or accelerate flame spreading and thus do not require inorganic fillers which are known to interfere with the adhesive function. Also, the adhesives are formulated to have sufficient tackiness so that a durable bond between the membrane and any rough or porous surface is experienced.

As discussed in the prior patents to Hohmann et al., namely, U.S. Pat. Nos. 6,945,000; 6,928,780; and, 6,584,746, the hot melt adhesive compositions of hot melt layer may be prepared from 10 to 50 weight percent of an isotactic thermoplastic polybutene-1/ethylene copolymer containing from about 5.5 to about 10% by weight ethylene(polybutylene); 20 to 50 percent of a tackifier; 15 to 50 percent of an amorphous diluent having a softening point greater than 90 degrees C.; 0 to 2 percent of a stabilizer; and 0 to 5 percent wax.

The polybutylene copolymers employed herein are copolymers of polybutene-1 and ethylene wherein the ethylene content varies from about 5.5 to about 10% by weight of the copolymer. The applicable isotactic polybutylenes are relatively rigid while in their plastic form but flow readily upon being heated. Expressing molecular weight in terms of melt index, the applicable isotactic polybutylenes to be used in the present adhesive should exhibit a melt index in the range of from about 5 to 2000 dg/min and preferably from 400 to 700 dg/min. The latter melt flow values are determined by the method described in ASTM D1238 and are inversely related to molecular weight, i.e., the lower the melt index, the higher the molecular weight. These copolymers are available from Shell Chemical Company under the Duraflex trademark as Duraflex 8310, 8410, 8510 and 8910, with the 8910 having a melt index of about 700, a grade preferred for use herein. Mixtures of these copolymers may also be used.

The tackifying resins which may be used to extend the adhesive properties of the isotactic polybutylene include: hydrogenated wood rosin or rosin ester; and, polyterpene resins having a softening point, as determined by an ASTM method E28-58 T, of from about 80 degrees C. to 150 degrees C. The latter polyterpene resins generally resulting from the polymerization of terpene hydrocarbons in the presence of Friedel-Crafts catalysts at moderately low temperatures and including the resins which are aromatically modified. Examples of commercially available resins of this type being the Nirez resins sold by Reichhold Chemical, the Zonatac resins sold by Arizona, and the Piccolyte S-10, S-25, S-40, S-85, S-100, S-115, S-125 and S-135 resins as sold by Hercules Chemical.

Other tackifying resins for this application are aliphatic petroleum hydrocarbon resins having a Ball and Ring softening point of from about 80 degrees C. to 160 degrees C., resulting from polymerization of monomers consisting primarily of 5 carbon atom olefins and diolefins, and including the latter resins which are aromatically modified. Examples of commercially available resins of this type being Wingtack 95 and Wingtack Extra as sold by the Goodyear Tire and Rubber Company and the Escorez 1000 series of resins sold by the Exxon Chemical Corporation. Also, partially and fully hydrogenated hydrocarbon resins such as Resin H-130 from Eastman, Escorez 5000 series from Exxon, and Regalrez from Hercules. The amorphous diluents which are needed and present in the adhesive composition include (atactic) amorphous polypropylene or other similar high softening point (i.e. greater than 90 degrees C.), low crystalline diluent, (e.g. amorphous polyalpha-olefins). These diluents, are used at levels of 20 to 50% by weight, preferably about 20 to 25% by weight.

To test the degree of tackiness of the above-described flashing structure, a pull test is performed. An 8-inch by 12-inch sample of the polymeric laminate is coated with a hot melt adhesive. A suitable release paper is applied thereover. After a prescribed cure period, the release paper is removed and the flashing of this invention is applied to the surface of a concrete block. The application to the concrete block is at room temperature utilizing a hand-operated laminating roller to provide the pressure activation. A spring scale is then attached to the masonry flashing and a 65 lb. force is required to peel the flashing from the block. Repeating the test for SBS-modified, peel-and-stick flashing, a force of 27 lb. (max.) is required to peel the flashing from the block.

Among the applicable stabilizers or antioxidants utilized herein are included high molecular weight hindered phenols and multifunctional phenols such as sulfur and phosphorous-containing phenols. Representative hindered phenols include: 1,3,5-trimethyl 2,4,6-tris(3,5-di-tert-butyl-4-hydroxy-benzyl)benzene; pentaerythrityl tetrakis-3(3,5-di-tert-butyl-4-hydroxyphenyl)propionate; 4,4′methylenbis(2,6-tert-butyl-phenol); 4,4′-thiobis(6-tert-butyl-o-cresol); 2,6-di-tertbutylphenol; 6-(4-hydroxyphenoxy)-2,4-bis(n-octyl-thio)-1,3,5-triazine; di-n-octadecyl 3,5-di-tert-butyl-4-hydroxy-benzylphosphonate; 2-(n-octylthio)ethyl 3,5-di-tert-butyl-4-hydroxybenzoate; and sorbitol hexa[3-(3,5-di-tert-butyl-4-hydroxyphenyl)-propionate].

The performance of these antioxidants may be further enhanced by utilizing, in conjunction therewith known synergists such, for example, as thiodipropionate esters and phosphites. Particularly useful is distearylthiodipropionate. These stabilizers are generally present in amounts of about up to 2 weight percent, preferably 0.25 to 1.0%. It is also possible to add minor amounts (i.e. less than about 5% by weight of the formulation) of other diluents such as (1) waxes including petroleum waxes such as a paraffin wax having a melting point of from about 50 degrees C. to 75 degrees C. and microcrystalline wax having a melting point of from about 60 degrees to 90 degrees C.; the latter melting points being determined by ASTM method D127-60; (2) low molecular weight (600 to 3000) liquid polybutene; (3) polyethylene greases having a softening point of from about 80 degrees C. to 100 degrees C. and a hardness value, as determined by ASTM method D-1321, of from about 60 degrees C. to 120 degrees C.; (4) hydrogenated animal, fish and vegetable fats and oil such as hydrogenated tallow, lard, soya oil, cottonseed oil, castor oil, menhaden oil and cod liver oil; and (5) synthetic waxes made by polymerizing carbon monoxide and hydrogen, such as Fischer-Tropsch wax.

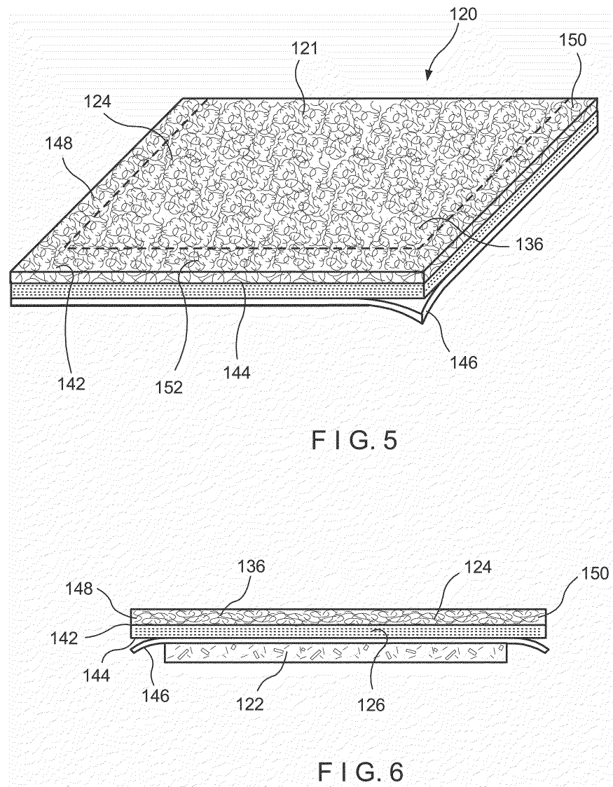

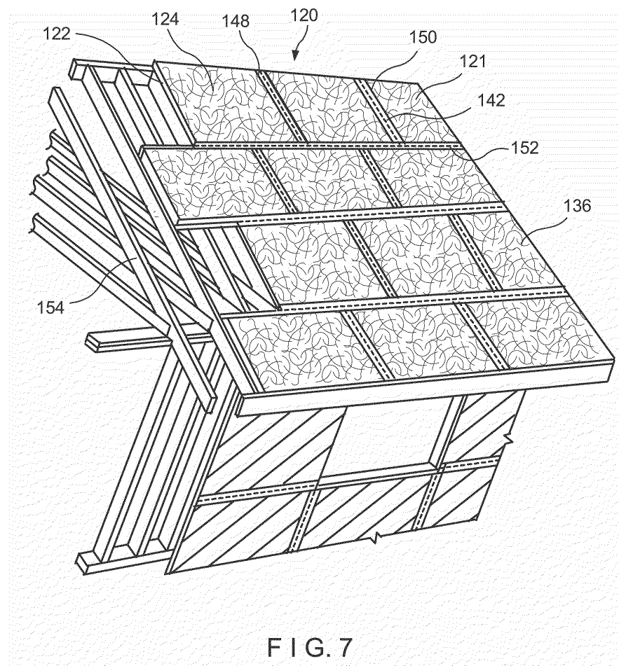

Referring now to FIGS. 5 through 7, a perspective view of the second embodiment of this invention in which a roofing system, referred to generally by the reference designator 120, is shown. In this embodiment, similar parts to those of the first embodiment are referred to by reference designators 100 units higher than a similar part in the first embodiment. Thus, for example, the textured coating 36 in the first embodiment has an analogous textured coating 136 in the second embodiment.

In this second embodiment, the subroof panel 121 consists of a substrate section 122, typically manufactured from composite wood and a roofing underlayment 124 adhered to the substrate 122 at the factory with the adhesive 126 present on the roofing underlayment 124. The roofing underlayment 124 consists of a textured coating 136, an adhesive layer 126 and extensions 142. The extensions 142 are a continuation of the roofing underlayment 124 with a release sheet 146 covering the mounting adhesive layer 144. The extensions 142 overlap the substrate section 122 by a minimum of 3 inches on each of the sides 148 and 150 and the lowermost portion 152 of the substrate 122. During installation, the extensions 142 overlap the adjacent subroof panels 121 and when the release sheet 146 is removed and pressed against the adjacent subroof panels 121, a watertight seal between the sections is obtained.

The subroof panels 121 are installed on the roof frame 154 using attaching hardware such as nails or other fasteners 140 (not shown) starting from the lowermost point on the roof frame 154 and working across and upwards towards the uppermost portion of the roof frame 154. The subroof panels 121 are set behind the primary roof covering or shingles 128 (not shown) and serve to protect against severe weather, especially rain, ice, snow and wind.

The adhesive layer 126 fills any holes created by the installation of the roof covering 128, and provide a leakproof surface. The adhesive layer 126 has sufficient tack to provide a seal around the attaching hardware 140. The subroof panel 121 is fastened to the roof frame 154 directly adjacent to any already installed subroof panels 121. The extensions 142 overlap the adjacent subroof panels 121. In the event that there is no adjacent subroof panel 121, the extension 142 is removed. Once the subroof panel 121 is fastened to the roof frame 154, the release sheet 146 on the extension 142 is removed, exposing the mounting adhesive layer 144. The mounting adhesive layer 144 is then adhered to the subroof panel 121, thereby providing a watertight seal between the subroof panels 121.

Once the initial subroof panel 121 is fastened to the roof frame 154, the craftsman walks on the subroof panel 121 and continues installing the remaining subroof panels 121 to the roof frame 154 and adhering the extensions 142 to the adjacent subroof panels 121 until the roof frame 154 is completely covered. The textured coating 136 of the roofing underlayment 124 serves to assist the craftsman in safely installing the subroof panels 121 and the shingles 128 (not shown). The textured coating 136 contains a patterned surface 150 that provides a high coefficient of friction, non-skid surface that allows the craftsman to install the subroof panels 121 and roof covering 128 in a safe manner. The roofing underlayment 124 is ultra-violet resistant, resisting deterioration from exposure to the sun.

The roofing underlayment 124 is composed of an textured coating 136 that is formed from cool roof materials such as Elvaloy® KEE (a Dupont registered trademark for ketone ethylene ester) or equivalent. Cool roof materials are highly reflective, highly emissive roofing materials that stay 50 to 60 degrees F. cooler than a normal tile roof under a hot summer sun. Such materials obtain up to a 0.919 level of emittance and up to a 0.87 level of initial reflectance. The level of reflectance after three years is up to 0.76. Cool roofs cut energy costs in roofing systems that have an air space between the roofing underlayment 124 and the roofing materials 128 by reducing the air conditioning load. The use of cool roof materials cut maintenance costs and increase the life expectancy of the roof. Because cool roofs save money and energy, in October 2005, cool roofs became part of California's energy code, the Title 24 Building Energy Efficiency Standards.

An adhesive layer 126 adhered to the textured coating 136 and is manufactured using environmentally friendly components. The adhesive layer 126 includes embedded recycled material—both inorganic (glass, fly ash, etc.) and organic (polymeric fibrous fragments, etc.)—to enhance tear and puncture resistance.

The adhesives described herein are particularly useful for peel-and-stick applications in building construction industry as such adhesives are readily pressure activated after the release paper is removed. The adhesive is formulated so that, in case of fire, the coatings thereof will not contribute to smoke or accelerate flame spreading and thus do not require inorganic fillers which are known to interfere with the adhesive function. Also, the adhesives are formulated to have sufficient tackiness so that a durable bond between the membrane and any rough or porous surface is experienced.

As discussed in the prior patents to Hohmann et al., namely, U.S. Pat. Nos. 6,945,000; 6,928,780; and, 6,584,746, the hot melt adhesive compositions of hot melt layer may be prepared from 10 to 50 weight percent of an isotactic thermoplastic polybutene-1/ethylene copolymer containing from about 5.5 to about 10% by weight ethylene(polybutylene); 20 to 50 percent of a tackifier; 15 to 50 percent of an amorphous diluent having a softening point greater than 90 degrees C.; 0 to 2 percent of a stabilizer; and 0 to 5 percent wax.

The polybutylene copolymers employed herein are copolymers of polybutene-1 and ethylene wherein the ethylene content varies from about 5.5 to about 10% by weight of the copolymer. The applicable isotactic polybutylenes are relatively rigid while in their plastic form but flow readily upon being heated. Expressing molecular weight in terms of melt index, the applicable isotactic polybutylenes to be used in the present adhesive should exhibit a melt index in the range of from about 5 to 2000 dg/min and preferably from 400 to 700 dg/min. The latter melt flow values are determined by the method described in ASTM D1238 and are inversely related to molecular weight, i.e., the lower the melt index, the higher the molecular weight. These copolymers are available from Shell Chemical Company under the Duraflex trademark as Duraflex 8310, 8410, 8510 and 8910, with the 8910 having a melt index of about 700, a grade preferred for use herein. Mixtures of these copolymers may also be used.

The tackifying resins which may be used to extend the adhesive properties of the isotactic polybutylene include: hydrogenated wood rosin or rosin ester; and, polyterpene resins having a softening point, as determined by an ASTM method E28-58 T, of from about 80 degrees C. to 150 degrees C. The latter polyterpene resins generally resulting from the polymerization of terpene hydrocarbons in the presence of Friedel-Crafts catalysts at moderately low temperatures and including the resins which are aromatically modified. Examples of commercially available resins of this type being the Nirez resins sold by Reichhold Chemical, the Zonatac resins sold by Arizona, and the Piccolyte S-10, S-25, S-40, S-85, S-100, S-115, S-125 and S-135 resins as sold by Hercules Chemical.

Other tackifying resins for this application are aliphatic petroleum hydrocarbon resins having a Ball and Ring softening point of from about 80 degrees C. to 160 degrees C., resulting from polymerization of monomers consisting primarily of 5 carbon atom olefins and diolefins, and including the latter resins which are aromatically modified. Examples of commercially available resins of this type being Wingtack 95 and Wingtack Extra as sold by the Goodyear Tire and Rubber Company and the Escorez 1000 series of resins sold by the Exxon Chemical Corporation. Also, partially and fully hydrogenated hydrocarbon resins such as Resin H-130 from Eastman, Escorez 5000 series from Exxon, and Regalrez from Hercules. The amorphous diluents which are needed and present in the adhesive composition include (atactic) amorphous polypropylene or other similar high softening point (i.e. greater than 90 degrees C.), low crystalline diluent, (e.g. amorphous polyalpha-olefins). These diluents, are used at levels of 20 to 50% by weight, preferably about 20 to 25% by weight.

To test the degree of tackiness of the above-described flashing structure, a pull test is performed. An 8-inch by 12-inch sample of the polymeric laminate is coated with a hot melt adhesive. A suitable release paper is applied thereover. After a prescribed cure period, the release paper is removed and the flashing of this invention is applied to the surface of a concrete block. The application to the concrete block is at room temperature utilizing a hand-operated laminating roller to provide the pressure activation. A spring scale is then attached to the masonry flashing and a 65 lb. force is required to peel the flashing from the block. Repeating the test for SBS-modified, peel-and-stick flashing, a force of 27 lb. (max.) is required to peel the flashing from the block.

Among the applicable stabilizers or antioxidants utilized herein are included high molecular weight hindered phenols and multifunctional phenols such as sulfur and phosphorous-containing phenols. Representative hindered phenols include: 1,3,5-trimethyl 2,4,6-tris(3,5-di-tert-butyl-4-hydroxy-benzyl)benzene; pentaerythrityl tetrakis-3(3,5-di-tert-butyl-4-hydroxyphenyl)propionate; 4,4′methylenbis(2,6-tert-butyl-phenol); 4,4′-thiobis(6-tert-butyl-o-cresol); 2,6-di-tertbutylphenol; 6-(4-hydroxyphenoxy)-2,4-bis(n-octyl-thio)-1,3,5-triazine; di-n-octadecyl 3,5-di-tert-butyl-4-hydroxy-benzylphosphonate; 2-(n-octylthio)ethyl 3,5-di-tert-butyl-4-hydroxybenzoate; and sorbitol hexa[3-(3,5-di-tert-butyl-4-hydroxyphenyl)-propionate].

The performance of these antioxidants may be further enhanced by utilizing, in conjunction therewith known synergists such, for example, as thiodipropionate esters and phosphites. Particularly useful is distearylthiodipropionate. These stabilizers are generally present in amounts of about up to 2 weight percent, preferably 0.25 to 1.0%. It is also possible to add minor amounts (i.e. less than about 5% by weight of the formulation) of other diluents such as (1) waxes including petroleum waxes such as a paraffin wax having a melting point of from about 50 degrees C. to 75 degrees C. and microcrystalline wax having a melting point of from about 60 degrees to 90 degrees C.; the latter melting points being determined by ASTM method D127-60; (2) low molecular weight (600 to 3000) liquid polybutene; (3) polyethylene greases having a softening point of from about 80 degrees C. to 100 degrees C. and a hardness value, as determined by ASTM method D-1321, of from about 60 degrees C. to 120 degrees C.; (4) hydrogenated animal, fish and vegetable fats and oil such as hydrogenated tallow, lard, soya oil, cottonseed oil, castor oil, menhaden oil and cod liver oil; and (5) synthetic waxes made by polymerizing carbon monoxide and hydrogen, such as Fischer-Tropsch wax.

Because many varying and different embodiments may be made within the scope of the inventive concept herein taught and because many modifications may be made in the embodiments herein detailed in accordance with the descriptive requirement of the law, it is to be understood that the details herein are to be interpreted as illustrative and not in a limiting sense.

What is claimed is:

1. A roofing underlayment for use with an overlying roofing material in a structure containing a roof, said roofing material optionally fastened thereto with attaching hardware, said roofing underlayment comprising:
a membranous backing layer having two major surfaces;
a textured coating disposed on said backing layer, said textured coating being highly reflective and emissive; and
a mounting adhesive layer disposed on the major surface opposite said textured coating, said mounting adhesive layer being a pressure-activated adhesive with 20 to 50 percent tackifier resin and adapted upon installation of said overlying roofing material to seal said attaching hardware;
whereby, upon installation, said roofing underlayment protects said roof from penetration by rain, wind, snow and ice.

2. A roofing underlayment as described in claim 1 wherein said textured coating is a non-skid membrane selected from a group consisting of foil, laminate, scrim, metalized foil film, polypropylene and polyethylene.

3. A roofing underlayment as described in claim 2 wherein said non-skid membrane comprises a material having a high coefficient of friction.

4. A roofing underlayment as described in claim 3 wherein said non-skid membrane causes said roof to remain 50 to 60 degrees F. cooler in high temperature surroundings.

5. A roofing underlayment as described in claim 1 wherein said mounting adhesive layer is an adhesive selected from a group consisting of a hot melt adhesive, a butyl-based adhesive, an acrylic adhesive, and a water-based adhesive.

6. A roofing underlayment as described in claim 5 wherein said mounting adhesive layer is a clear hot melt adhesive.

7. A roofing underlayment as described in claim 6 wherein said hot melt adhesive comprises about 10 to 50 percent by weight of an isotactic thermoplastic, about 5.5 to 10 percent by weight of ethylene; 15 to 50 percent by weight of an amorphous diluent; 0 to 2 percent by weight of a stabilizer; and 0 to 5 percent by weight of wax.

8. A roofing underlayment as described in claim 7 wherein said tackifier resin is selected from a group consisting of hydrogenated wood rosin, rosin ester, polyterpene resins, and aliphatic petroleum hydrocarbon resins.

9. A roofing underlayment as described in claim 7 wherein said isotactic thermoplastic is a mixture of polybutylene copolymers.

10. A roofing underlayment as described in claim 9 wherein said polybutylene copolymers are polybutene and ethylene copolymer.

11. A roofing underlayment as described in claim 6 wherein said mounting adhesive layer is a filled adhesive, said mounting adhesive layer further comprising recycled inorganic and organic materials.

12. A roofing underlayment as described in claim 1 further comprising:
a release sheet adhered to said mounting adhesive layer, said release sheet being removable prior to mounting of said roofing underlayment membrane.

13. A roofing underlayment as described in claim 1 wherein said roofing underlayment is UV resistant.

14. A roofing underlayment as described in claim 1 wherein said roofing material are selected from a group consisting of shingles, tiles, slate, metal panels, and wood shakes.

15. A subroof panel for use in a structure containing a roof having roof framing members and an overlying roofing material, said roofing material optionally fastened thereto with attaching hardware, said subroof panel comprising:
a substrate composed of a wood composite;
a membranous backing layer having two major surfaces;
a textured coating disposed on said backing layer, said textured coating being highly reflective and emissive; and
an adhesive layer disposed on the major surface opposite said textured coating, said adhesive layer with 20 to 50 percent tackifier resin and adapted upon installation of said overlying roofing material to seal said attaching hardware; and
an extension layer extending beyond said substrate, said extension layer adapted upon installation to adhere to a second subroof panel, said extension layer further comprising:
a second membranous backing layer having two major surfaces;
a second textured coating disposed on said second backing layer, said textured coating being highly reflective and emissive; and
a mounting adhesive layer disposed on the major surface opposite said second textured coating, said mounting adhesive layer being a pressure-activated adhesive with 20 to 50 percent tackifier resin and adapted upon installation of said roofing material to seal said attaching hardware; and
a release sheet adhered to said mounting adhesive layer, said release sheet being removable prior to mounting of said subroof panel;
whereby, upon installation of said subroof panel on said roof, said subroof panel protects said roof from penetration by rain, wind, snow and ice.

16. A subroof panel as described in claim 15 wherein said textured coating and said second textured coating are non-skid reflective membranes selected from a group consisting of foil, laminate, scrim, metalized foil film, polypropylene and polyethylene.

17. A subroof panel as described in claim 16 wherein said non-skid membrane comprises a material having a high coefficient of friction.

18. A subroof panel as described in claim 15 wherein said mounting adhesive layer is an adhesive selected from a group consisting of a hot melt adhesive, a butyl-based adhesive, an acrylic adhesive, and a water-based adhesive.

19. A subroof panel as described in claim 18 wherein said hot melt adhesive comprises about 10 to 50 percent by weight of an isotactic thermoplastic, about 5.5 to 10 percent by weight of ethylene; 15 to 50 percent by weight of an amorphous diluent; 0 to 2 percent by weight of a stabilizer; and 0 to 5 percent by weight of wax.

20. A subroof panel as described in claim 19 wherein said tackifier resin is selected from a group consisting of hydrogenated wood rosin, rosin ester, polyterpene resins, and aliphatic petroleum hydrocarbon resins.

21. A subroof panel as described in claim 19 wherein said isotactic thermoplastic is a mixture of polybutylene copolymers.

22. A subroof panel as described in claim 21 wherein said polybutylene copolymers are polybutene and ethylene copolymer.

23. A subroof panel as described in claim 15 wherein said adhesive layer and said mounting adhesive layer are a filled adhesive, said adhesive layer and said mounting adhesive layer further comprising recycled inorganic and organic materials.

24. A subroof panel as described in claim 15 wherein said textured coating and said second textured coating are UV resistant.

25. A subroof panel as described in claim 15 wherein said roofing materials are selected from a group consisting of shingles, tiles, slate, metal panels, and wood shakes.
